(19) United States
(12) Patent Application Publication
(10) Pub. No.: US 2022/0294388 A1
(43) Pub. Date: Sep. 15, 2022

(54) PHOTOVOLTAIC SYSTEM

(71) Applicant: Huawei Digital Power Technologies Co., Ltd., Futian District (CN)

(72) Inventors: Xun WANG, Shanghai (CN); Yanzhong ZHANG, Shanghai (CN)

(21) Appl. No.: 17/826,903

(22) Filed: May 27, 2022

Related U.S. Application Data
(63) Continuation of application No. PCT/CN2020/116786, filed on Sep. 22, 2020.

(30) Foreign Application Priority Data
Nov. 29, 2019 (CN) 201911205767.7

(51) Int. Cl. H02S 40/32; H02S 40/36; H02S 40/38; H02J 3/32; H02J 3/38

(52) U.S. Cl. CPC H02S 40/32; H02S 40/36; H02S 40/38; H02J 3/32; H02J 3/381; H02J 2300/24

(57) ABSTRACT

Embodiments of this application disclose a photovoltaic system, to resolve a problem of high costs per kilowatt hour of a photovoltaic system. The photovoltaic system includes a first photovoltaic array, a first power converter, a second photovoltaic array, a second power converter, an energy storage converter, a storage battery, and a photovoltaic inverter. The first photovoltaic array is connected to the photovoltaic inverter through the first power converter. The second photovoltaic array is directly connected to the energy storage converter, or at least one part of the second photovoltaic array is connected to the energy storage converter through the second power converter. The energy storage converter is connected to the photovoltaic inverter and the storage battery. The photovoltaic inverter is connected to a power grid.

### CROSS-REFERENCE TO RELATED APPLICATIONS

This application is a continuation of International Application No. PCT/CN2020/116786, filed on Sep. 22, 2020, which claims priority to Chinese Patent Application No. 201911205767.7, filed on Nov. 29, 2019. The disclosures of the aforementioned applications are hereby incorporated by reference in their entireties.

### TECHNICAL FIELD

This application relates to the field of photovoltaic power generation technologies, and in particular, to a photovoltaic system.

### BACKGROUND

As clean renewable energy, photovoltaic power generation is widely used. A photovoltaic system can convert light energy into electrical energy, and supply power to a power grid. A photovoltaic system generally includes a photovoltaic array, a power converter, a photovoltaic inverter, and an energy storage apparatus. The photovoltaic array converts received light energy into a direct current. The power converter can improve efficiency of outputting a direct current by the photovoltaic array, and output the direct current obtained through efficiency conversion to the photovoltaic inverter. The photovoltaic inverter may convert the direct current output by the power converter into an alternating current, and then output the alternating current to a power grid. The energy storage apparatus is configured to store excess electrical energy (electrical energy that exceeds that required by the power grid) generated by the photovoltaic array.

In a photovoltaic system, in actual application, a capability of inverting a direct current by a photovoltaic inverter is equal to a capability of outputting a direct current by a photovoltaic array. On particular occasions (for example, from 10:00 a.m. to 3:00 p.m.), the photovoltaic array generates a relatively large amount of electrical energy at this moment while a power grid requires a relatively small amount of electrical energy, and the electrical energy output by the photovoltaic array does not need to be completely transmitted to the power grid. In contrast, on some other occasions (for example, 6:00 a.m. to 8:00 a.m., and after 5:00 p.m.), a power grid requires a relatively large amount of electrical energy, and electrical energy generated by the photovoltaic array cannot satisfy a requirement of the power grid. In this case, no energy storage apparatus is required to store the electrical energy. An energy storage apparatus is used only when light is insufficient. Costs of the energy storage apparatus are relatively high, and disposing the energy storage apparatus undoubtedly increases costs per kilowatt hour of the photovoltaic system when the energy storage apparatus is not frequently used.

### SUMMARY

Embodiments of this application provide a photovoltaic system, to resolve a problem of high costs per kilowatt hour of a photovoltaic system.

An embodiment of this application provides a photovoltaic system. The photovoltaic system includes a first photovoltaic array, a first power converter, a second photovoltaic array, a second power converter, an energy storage converter, a storage battery, and a photovoltaic inverter. The first photovoltaic array is connected to the photovoltaic inverter through the first power converter. The second photovoltaic array is directly connected to the energy storage converter, or at least one part of the second photovoltaic array is connected to the energy storage converter through the second power converter. The energy storage converter is connected to the photovoltaic inverter and the storage battery. The photovoltaic inverter is connected to a power grid.

The first photovoltaic array may be configured to: convert absorbed light energy into a first direct current, and output the first direct current to the first power converter. The first power converter may be configured to: convert the received first direct current into a second direct current, and output the second direct current to the photovoltaic inverter. When the second photovoltaic array is connected to the energy storage converter through the second power converter, the second photovoltaic array may be configured to: convert absorbed light energy into a third direct current, and output the third direct current to the second power converter. The second power converter converts the received third direct current into a fourth direct current. The energy storage converter may be configured to: receive the second direct current and the fourth direct current, convert voltage values of the received direct currents into charging voltages of the storage battery, and output converted direct currents to the storage battery for storage. The energy storage converter may further be configured to: obtain the direct currents from the storage battery, convert the obtained direct currents into alternating currents by using the photovoltaic inverter, and output the alternating currents to the power grid. When one part of the second photovoltaic array is directly connected to the energy storage converter and the other part of the second photovoltaic array is connected to the energy storage converter through the second power converter, the second photovoltaic array converts absorbed light energy into a third direct current, outputs one part of the third direct current to the energy storage converter, and outputs the other part of the third direct current to the second power converter. The second power converter may be configured to: convert the received other part of the third direct current into a fourth direct current, and output the fourth direct current to the energy storage converter. The energy storage converter may be configured to: receive the second direct current, the part of the third direct current, and the fourth direct current, convert voltage values of the received direct currents into charging voltages of the storage battery, and output converted direct currents to the storage battery for storage. The energy storage converter may further be configured to: obtain the direct currents from the storage battery, convert the obtained direct currents into alternating currents by using the photovoltaic inverter, and output the alternating currents to the power grid. When the second photovoltaic array is directly connected to the energy storage converter, the second photovoltaic array may be configured to: convert absorbed light energy into a third direct current, and output the third direct current to the energy storage converter. The energy storage converter is configured to: receive the second direct current and the third direct current, convert voltage values of the received direct currents into charging voltages of the storage battery, and output converted direct currents to the storage battery for storage. The energy storage converter may further be configured to: obtain the direct currents from the storage battery, convert the obtained direct currents into alternating currents by using the photovoltaic inverter, and output the alternating currents to the power grid. The photovoltaic inverter may be configured to: obtain the direct current output by the first power converter or the direct currents output by the energy storage converter, or obtain the direct current output by the first power converter and the direct currents output by the energy storage converter, convert the obtained direct current into an alternating current, and output the alternating current to the power grid.

It should be understood that, when an amount of electrical energy transmitted on the power grid per unit time is greater than that required by the power grid per unit time, to avoid a waste of electrical energy, remaining electrical energy (electrical energy that exceeds the electrical energy required by the power grid per unit time) may be converted into a direct current by using the photovoltaic inverter, and then the direct current may be stored in the storage battery.

By using the foregoing system architecture, the energy storage converter may have a plurality of electrical energy obtaining paths. In addition to obtaining electrical energy from the first power converter at present, the energy storage converter may obtain electrical energy directly from the second photovoltaic array, or may obtain electrical energy from the second power converter, or may obtain electrical energy from the power grid. This improves utilization of the energy storage converter and the storage battery, and improves utilization of the electrical energy, thereby reducing costs per kilowatt hour of the photovoltaic system.

In one embodiment, the energy storage converter includes at least one first input port, at least one second input port, and at least one output port. The at least one first input port is connected to the photovoltaic inverter. The at least one second input port is connected to the second power converter, or the at least one second input port is connected to the second photovoltaic array, or some of the at least one second input port are connected to the second power converter and the other some of the at least one second input port are connected to the second photovoltaic array. The at least one output port is connected to the storage battery.

By using the foregoing system architecture, the energy storage converter may be connected to an external apparatus through a plurality of ports, to obtain a plurality of electrical energy transmission paths, thereby flexibly selecting an electrical energy transmission path.

In one embodiment, the energy storage converter further includes: at least one first switch connected to the at least one first input port in a one-to-one correspondence manner; at least one second switch connected to the at least one second input port in a one-to-one correspondence manner; at least one third switch connected to the at least one output port in a one-to-one correspondence manner; and one first DC-DC converter. Each of the at least one first input port is connected to an input end of the first DC-DC converter through a correspondingly connected first switch. Each of the at least one second input port is connected to an input end of the first DC-DC converter through a correspondingly connected second switch. Each of the at least one output port is connected to an output end of the first DC-DC converter through a correspondingly connected third switch.

The first DC-DC converter may be configured to: obtain a direct current from the at least one first input port, or obtain a direct current from the at least one second input port, or obtain direct currents from the at least one first input port and the at least one second input port, reduce a voltage value of the obtained direct current, and supply a voltage-reduced direct current to the storage battery through the at least one output port; or increase a voltage value of the direct current that is supplied by the storage battery and that is obtained from the at least one output port, and output a voltage-increased direct current to the photovoltaic inverter through the at least one first input port.

That the at least one first input port is connected to the at least one first switch in a one-to-one correspondence manner means that a quantity of first input ports included in the at least one first input port is equal to a quantity of first switches included in the at least one first switch, each of the at least one first input port is corresponding to one matched first switch, the first switches matched for all the first input ports are different from each other, and each first input port is connected to its matched first switch. That the at least one second input port is connected to the at least one second switch in a one-to-one correspondence manner means that a quantity of second input ports included in the at least one second input port is equal to a quantity of second switches included in the at least one second switch, each of the at least one second input port is corresponding to one matched second switch, the second switches matched for all the second input ports are different from each other, and each second input port is connected to its matched second switch. That the at least one output port is connected to the at least one third switch in a one-to-one correspondence manner means that a quantity of output ports included in the at least one output port is equal to a quantity of third switches included in the at least one third switch, each of the at least one output port is corresponding to one matched third switch, the third switches matched for all the output ports are different from each other, and each output port is connected to its matched third switch.

By using the foregoing system architecture, the energy storage converter may obtain electrical energy from a plurality of input ports, and output the obtained electrical energy to the storage battery for storage, to supply the electrical energy stored in the storage battery to the power grid when the power grid requires a relatively large amount of electrical energy or the first photovoltaic array generates a relatively small amount of electrical energy. This satisfies a requirement of the power grid for electrical energy.

In one embodiment, the energy storage converter further includes: at least one first DC-DC converter; at least one second DC-DC converter; at least one first switch connected to the at least one first input port in a one-to-one correspondence manner, where the at least one first switch is connected to the at least one first DC-DC converter in a one-to-one correspondence manner; at least one second switch connected to the at least one second input port in a one-to-one correspondence manner, where the at least one second switch is connected to the at least one second DC-DC converter in a one-to-one correspondence manner; and at least one third switch connected to the at least one output port in a one-to-one correspondence manner, where each of the at least one third switch is connected to one first DC-DC converter or one second DC-DC converter.

Each of the at least one first DC-DC converter may be configured to: obtain a direct current from a connected first input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through the connected first input port. Each of the at least one second DC-DC converter may be configured to: obtain a direct current from a connected second input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through a connected first input port.

That the at least one first switch is connected to the at least one first DC-DC converter in a one-to-one correspondence manner means that a quantity of first switches included in the at least one first switch is equal to a quantity of first DC-DC converters included in the at least one first DC-DC converter, each of the at least one first switch is corresponding to one matched first DC-DC converter, the first DC-DC converters matched for all the first switches are different from each other, and each first switch is connected to its matched first DC-DC converter. That the at least one second switch is connected to the at least one second DC-DC converter in a one-to-one correspondence manner means that a quantity of second switches included in the at least one second switch is equal to a quantity of second DC-DC converters included in the at least one second DC-DC converter, each of the at least one second switch is corresponding to one matched second DC-DC converter, the second DC-DC converters matched for all the second switches are different from each other, and each second switch is connected to its matched second DC-DC converter.

By using the foregoing system architecture, the energy storage converter may obtain electrical energy from a plurality of input ports. To ensure that the plurality of input ports do not affect each other, one first DC-DC converter or one second DC-DC converter may be configured for each input port (a first input port and a second input port) of the energy storage converter. In this way, when a fault occurs on a single input port, electrical energy can be obtained from another port, to implement a corresponding function of the energy storage converter.

In one embodiment, the energy storage converter further includes a controller; and the controller is configured to control on or off of the at least one first switch, the at least one second switch, and the at least one third switch.

By using the foregoing system architecture, a device connected to the energy storage converter can be flexibly selected under the control of the controller, to control a transmission direction of electrical energy.

In one embodiment, the first photovoltaic array includes a plurality of first photovoltaic subarrays, and the first power converter includes a plurality of first photovoltaic ports connected to the plurality of first photovoltaic subarrays in a one-to-one correspondence manner; the photovoltaic inverter includes a direct current port, and the first power converter includes an output port; and the output port of the first power converter is connected to the direct current port.

That the plurality of first photovoltaic subarrays are connected to the plurality of first photovoltaic ports in a one-to-one correspondence manner means that a quantity of first photovoltaic subarrays included in the plurality of first photovoltaic subarrays is equal to a quantity of first photovoltaic ports included in the plurality of first photovoltaic ports, each of the plurality of first photovoltaic subarrays is corresponding to one matched first photovoltaic port, the first photovoltaic ports matched for all the first photovoltaic subarrays are different from each other, and each first photovoltaic subarray is connected to its matched first photovoltaic port.

Because a single first photovoltaic subarray has a limited capability of outputting electrical energy, by using the foregoing system architecture, the plurality of first photovoltaic subarrays may be disposed to simultaneously output electrical energy, to satisfy a requirement of the power grid for electrical energy.

In one embodiment, the second photovoltaic array includes a plurality of second photovoltaic subarrays. When the plurality of second photovoltaic subarrays are all connected to the energy storage converter through the second power converter, a plurality of second photovoltaic ports included in the second power converter are connected to the plurality of second photovoltaic subarrays in a one-to-one correspondence manner, and the at least one second input port of the energy storage converter is connected to an output port of the second power converter. When some of the plurality of second photovoltaic subarrays are directly connected to the energy storage converter and some other second photovoltaic subarrays are connected to the energy storage converter through the second power converter, some of the at least one second input port included in the energy storage converter are connected to the some second photovoltaic subarrays in a one-to-one correspondence manner, a plurality of second photovoltaic ports included in the second power converter are connected to the some other second photovoltaic subarrays in a one-to-one correspondence manner, and an output port of the second power converter is connected to some other second input ports included in the energy storage converter. When the plurality of second photovoltaic subarrays are all directly connected to the energy storage converter, the at least one second input port included in the energy storage converter is connected to the plurality of second photovoltaic subarrays in a one-to-one correspondence manner.

That the plurality of second photovoltaic ports are connected to the plurality of second photovoltaic subarrays in a one-to-one correspondence manner means that a quantity of second photovoltaic ports included in the plurality of second photovoltaic ports is equal to a quantity of second photovoltaic subarrays included in the plurality of second photovoltaic subarrays, each of the plurality of second photovoltaic ports is corresponding to one matched second photovoltaic subarray, the second photovoltaic subarrays matched for all the second photovoltaic ports are different from each other, and each second photovoltaic port is connected to its matched second photovoltaic subarray. That the some of the at least one second input port are connected to the some second photovoltaic subarrays in a one-to-one correspondence manner means that a quantity of second input ports included in the some second input ports is equal to a quantity of second photovoltaic subarrays included in the some second photovoltaic subarrays, each of the some second input ports is corresponding to one matched second photovoltaic subarray (one of the some second photovoltaic subarrays), the second photovoltaic subarrays matched for all the second input ports are different from each other, and each second input port is connected to its matched second photovoltaic subarray. That the plurality of second photovoltaic ports are connected to the some other second photovoltaic subarrays in a one-to-one correspondence manner means that a quantity of second photovoltaic ports included in the plurality of second photovoltaic ports is equal to a quantity of second photovoltaic subarrays included in the some other second photovoltaic subarrays, each of the plurality of second photovoltaic ports is corresponding to one matched second photovoltaic subarray (one of the some other second photovoltaic subarrays), the second photovoltaic subarrays matched for all the second photovoltaic ports are different from each other, and each second photovoltaic port is connected to its matched second photovoltaic subarray. That the at least one second input port is connected to the plurality of second photovoltaic subarrays in a one-to-one correspondence manner means that a quantity of second input ports included in the at least one second input port is equal to a quantity of second photovoltaic subarrays included in the plurality of second photovoltaic subarrays, each of the at least one second input port is corresponding to one matched second photovoltaic subarray, the second photovoltaic subarrays matched for all the second input ports are different from each other, and each second input port is connected to its matched second photovoltaic subarray.

Because a single second photovoltaic subarray has a limited capability of outputting electrical energy, by using the foregoing system architecture, the plurality of second photovoltaic subarrays may be used to simultaneously output electrical energy, to satisfy a requirement of the power grid for electrical energy. The second photovoltaic array is connected to the energy storage converter in a plurality of manners. The second photovoltaic array may be directly connected to the energy storage converter, and a direct current output by the second photovoltaic array does not need to pass through the second power converter, thereby improving utilization of the direct current output by the second photovoltaic array. Alternatively, the second photovoltaic array may be partially or completely connected to the energy storage converter through the second power converter. A major portion of the direct current received by the energy storage converter is a direct current output by the second power converter. Therefore, stability of a voltage value of the direct current output to the energy storage converter is ensured.

In one embodiment, the first power converter includes a plurality of third DC-DC converters connected to the plurality of first photovoltaic ports in a one-to-one correspondence manner, an input end of each of the plurality of third DC-DC converters is connected to a corresponding first photovoltaic port, and an output end of each of the plurality of third DC-DC converters is connected to the output port of the first power converter.

Each of the plurality of third DC-DC converters may be configured to: receive, from a connected first photovoltaic port, a direct current output by a first photovoltaic subarray, convert a voltage value of the received direct current, and output a converted direct current to the photovoltaic inverter through the output port of the first power converter connected to the third DC-DC converter.

Because each first photovoltaic subarray can output a direct current, to ensure that the first photovoltaic subarrays do not affect each other, one third DC-DC converter may be configured for each first photovoltaic subarray by using the foregoing system architecture, to implement mutual non-interference between first photovoltaic arrays.

In one embodiment, the second power converter includes a plurality of fourth DC-DC converters connected to the plurality of second photovoltaic ports in a one-to-one correspondence manner, an input end of each of the plurality of fourth DC-DC converters is connected to a corresponding second photovoltaic port, and an output end of each of the plurality of fourth DC-DC converters is connected to the output port of the second power converter.

Each of the plurality of fourth DC-DC converters may be configured to: receive, from a connected second photovoltaic port, a direct current output by a second photovoltaic subarray, convert a voltage value of the received direct current, and output a converted direct current to the energy storage converter through the output port of the second power converter connected to the fourth DC-DC converter.

Because each second photovoltaic subarray can output a direct current, to ensure that the second photovoltaic subarrays do not affect each other, one fourth DC-DC converter may be configured for each second photovoltaic subarray by using the foregoing system architecture, to implement mutual non-interference between the second photovoltaic subarrays.

In one embodiment, the photovoltaic inverter includes an alternating current port, a direct current bus, and an AC/DC adapter. The direct current bus is connected between the direct current port and an input end of the AC/DC adapter. An output end of the AC/DC adapter is connected to the alternating current port, and the alternating current port is connected to the power grid.

The AC/DC adapter may be configured to: receive a direct current from the connected direct current port, convert the received direct current into an alternating current, output the alternating current to the power grid through the alternating current port, convert the alternating current that is output by the power grid and that is received from the connected alternating current port into a direct current, and output the direct current to the energy storage converter through the direct current port.

By using the foregoing system architecture, when an amount of electrical energy transmitted on the power grid per unit time is greater than that required by the power grid per unit time, excess electrical energy transmitted on the power grid may be converted into a direct current, and then the converted direct current may be stored in the storage battery by using the energy storage converter.

In one embodiment, a voltage value of a voltage output by the second power converter is greater than or equal to 1500 V.

By using the foregoing system architecture, that the voltage value of the voltage output by the second power converter is greater than or equal to 1500 V facilitates long-distance transmission of electrical energy.

In one embodiment, the storage battery includes a plurality of storage sub-batteries, every two of the plurality of storage sub-batteries are adjacent to each other, positive wiring terminals of any two adjacent storage sub-batteries are connected, and negative wiring terminals of the any two adjacent storage sub-batteries are connected.

By using the foregoing system architecture, a connection manner in which positive wiring terminals of every two adjacent storage sub-batteries are connected and negative wiring terminals of the every two adjacent storage sub-batteries are connected can implement a parallel connection between the storage batteries; each storage battery can obtain the direct current output by the energy storage converter, without being connected to an energy storage apparatus by using two connecting wires; and a connecting wire path between the storage battery and the energy storage converter is reduced.

In one embodiment, the storage battery includes a lead carbon battery, a lithium iron phosphate battery, a ternary polymer lithium battery, a sodium sulfur battery, or a flow battery.

### BRIEF DESCRIPTION OF DRAWINGS

FIG. 1 is a schematic diagram of a system architecture of a direct current coupled photovoltaic system;

FIG. 2 is a schematic diagram 1 of an architecture of a photovoltaic system according to an embodiment of this application;

FIG. 3 is a schematic diagram 2 of an architecture of a photovoltaic system according to an embodiment of this application;

FIG. 4 is a schematic diagram 3 of an architecture of a photovoltaic system according to an embodiment of this application;

FIG. 5 is a schematic diagram of a structure of a first photovoltaic array;

FIG. 6 is a schematic diagram of a structure of a second DC-DC converter;

FIG. 7 is a possible schematic diagram 4 of an architecture of a photovoltaic system according to an embodiment of this application;

FIG. 8 is a possible schematic diagram 5 of a circuit of a photovoltaic system according to an embodiment of this application; and

FIG. 9 is a possible schematic diagram 6 of a circuit of a photovoltaic system according to an embodiment of this application.

### DESCRIPTION OF EMBODIMENTS

The following further describes, in detail, embodiments of this application with reference to the accompanying drawings.

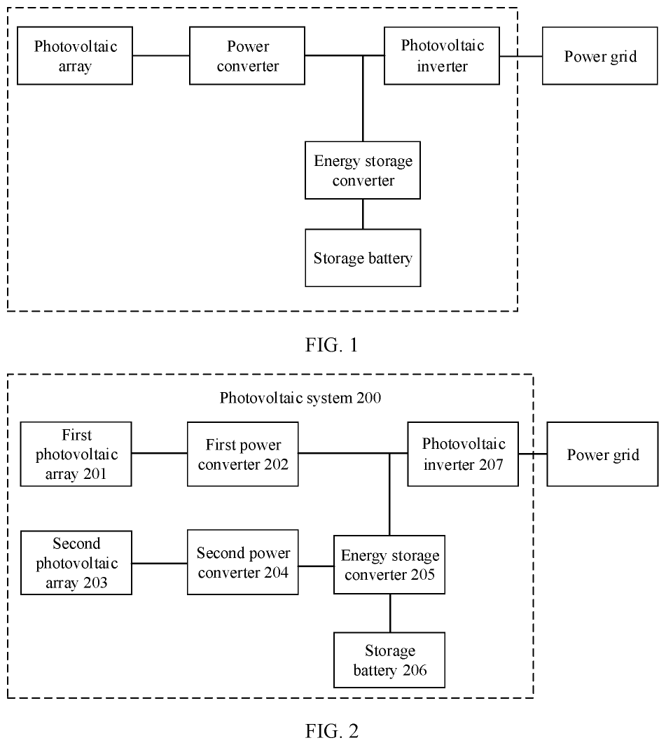

FIG. 1 is a schematic diagram of a system architecture of a direct current coupled photovoltaic system. As shown in FIG. 1, the photovoltaic system includes a photovoltaic array, a power converter, an energy storage converter, a storage battery, and a photovoltaic inverter. The photovoltaic array is connected to the power converter, and is configured to: convert absorbed light energy into a direct current, and output the converted direct current to the power converter. The power converter is connected to both the energy storage converter and the photovoltaic inverter, and is configured to: adjust power of the direct current output by the photovoltaic array, and when an amount of electrical energy generated by the photovoltaic array per unit time is greater than that required by a power grid per unit time, output a direct current whose power has been adjusted to both the energy storage converter and the photovoltaic inverter. The energy storage converter is connected to the photovoltaic inverter and the storage battery, and is configured to convert the direct current received from the power converter into a charging voltage of the storage battery, to supply electrical energy to the storage battery. The photovoltaic inverter is configured to: convert the received direct current into an alternating current, and output the alternating current to the power grid.

For the photovoltaic system shown in FIG. 1, when light is sufficient, if electrical energy generated by the photovoltaic array in this case is exactly electrical energy required by the power grid, the electrical energy generated by the photovoltaic array is directly output to the power grid through the photovoltaic inverter. The storage battery and the energy storage converter can obtain electrical energy only when the power grid requires a relatively small amount of electrical energy and light is sufficient, and the storage battery has only one charging path, that is, the photovoltaic inverter. However, costs of configuring the storage battery and the energy storage converter for the photovoltaic system are relatively high, and utilization of the storage battery and the energy storage converter is low. This undoubtedly increases costs per kilowatt hour of the photovoltaic system.

In view of this, an embodiment of this application provides a photovoltaic system, to reduce costs per kilowatt hour of the photovoltaic system.

In detailed descriptions of the following embodiments, it should be noted that “a plurality of” in this application means at least two. A term “or” in this application describes an association relationship between associated objects and represents that two relationships may exist. For example, A or B may represent the following two cases: Only A exists and only B exists. A connection in this application describes a connection relationship between two objects and may represent two connection relationships. For example, that A is connected to B may represent the following two cases: A is directly connected to B, and A is connected to B through C. In addition, it should be understood that, in descriptions of this application, terms such as “first”, “second”, and “third” are merely used for differentiation and description, but cannot be understood as an indication or implication of relative importance or an indication or implication of an order.

To resolve the foregoing problem of the photovoltaic system, an embodiment of this application provides three photovoltaic system structures. Details are as follows.

FIG. 2 is a schematic diagram 1 of an architecture of a photovoltaic system according to an embodiment of this application. As shown in FIG. 2, the photovoltaic system 200 may include a first photovoltaic array 201, a first power converter 202, a second photovoltaic array 203, a second power converter 204, an energy storage converter 205, a storage battery 206, and a photovoltaic inverter 207.

The first photovoltaic array 201 is connected to the photovoltaic inverter 207 through the first power converter 202. The second photovoltaic array 203 is connected to the energy storage converter 205 through the second power converter 204. The energy storage converter 205 is connected to both the photovoltaic inverter 207 and the storage battery 206. The photovoltaic inverter 207 is connected to a power grid.

The first photovoltaic array 201 may be configured to: convert absorbed light energy into a first direct current, and output the first direct current to the first power converter 202. The first power converter 202 may be configured to convert the received first direct current into a second direct current. The second photovoltaic array 203 may be configured to convert absorbed light energy into a third direct current. The second power converter 204 may be configured to: receive the third direct current, and convert the third direct current into a fourth direct current. The energy storage converter 205 may be configured to: receive at least one of the second direct current and the fourth direct current, convert a voltage value of the received direct current into a charging voltage of the storage battery 206, store a converted direct current in the storage battery 206, and output the direct current stored in the storage battery 206 to the photovoltaic inverter 207. The storage battery 206 may be configured to store the direct current supplied by the energy storage converter 205 or supply a direct current to the energy storage converter 205. The photovoltaic inverter 207 may be configured to: receive at least one of the direct currents output by the energy storage converter 205 and the first power converter 202, convert the received direct current into an alternating current, output the alternating current to the power grid, convert an alternating current input by the power grid into a direct current, and output the direct current to the energy storage converter 205. To implement long-distance transmission of electrical energy output by the photovoltaic system 200, a voltage value of the second direct current may be greater than or equal to 1500 V.

The voltage value of the second direct current is equal to that of the fourth direct current, and positive and negative directions of the second direct current may be the same as those of the fourth direct current.

In the photovoltaic system 200 shown in FIG. 2, the energy storage converter 205 has a plurality of paths for obtaining a direct current. In one embodiment, the first power converter 202 may be connected to the energy storage converter 205, and the second power converter 204 may also be connected to the energy storage converter 205. When the photovoltaic system 200 supplies electrical energy to the power grid, on some occasions when a small amount of electrical energy is required, electrical energy required by the power grid may be directly supplied by the first power converter 202; and after electrical energy generated by the second photovoltaic array 203 is converted into the fourth direct current by using the second power converter, the voltage value of the fourth direct current may be converted into the charging voltage of the storage battery 206 by using the energy storage converter 205, and a converted direct current may be stored in the storage battery 206 by using the energy storage converter 205. When electrical energy generated by the first photovoltaic array 201 cannot satisfy a requirement of the power grid for electrical energy, at least one of the direct current output by the second power converter 204 and the direct current stored in the storage battery 206 is converted into an alternating current by using the photovoltaic inverter 207, and then the alternating current is supplied to the power grid. This operation method improves utilization of the energy storage converter 205 and the storage battery 206, thereby reducing costs per kilowatt hour of the photovoltaic system.

It should be understood that, when an amount of electrical energy generated by the first photovoltaic array 201 is greater than that required by the power grid, to avoid a waste of electrical energy, excess electrical energy output by the first power converter 202 (an electrical energy portion that exceeds electrical energy required by the power grid per unit time) may be stored in the storage battery 206 by using the energy storage converter 205.

It should be understood that, when an amount of electrical energy transmitted on the power grid per unit time is greater than that required by the power grid per unit time, to avoid a waste of electrical energy, excess electrical energy transmitted on the power grid (an electrical energy portion that exceeds the electrical energy required by the power grid per unit time) may be converted into a direct current by using the photovoltaic inverter 207, and then the direct current may be stored in the storage battery 206 by using the energy storage converter 205. This improves utilization of the electrical energy.

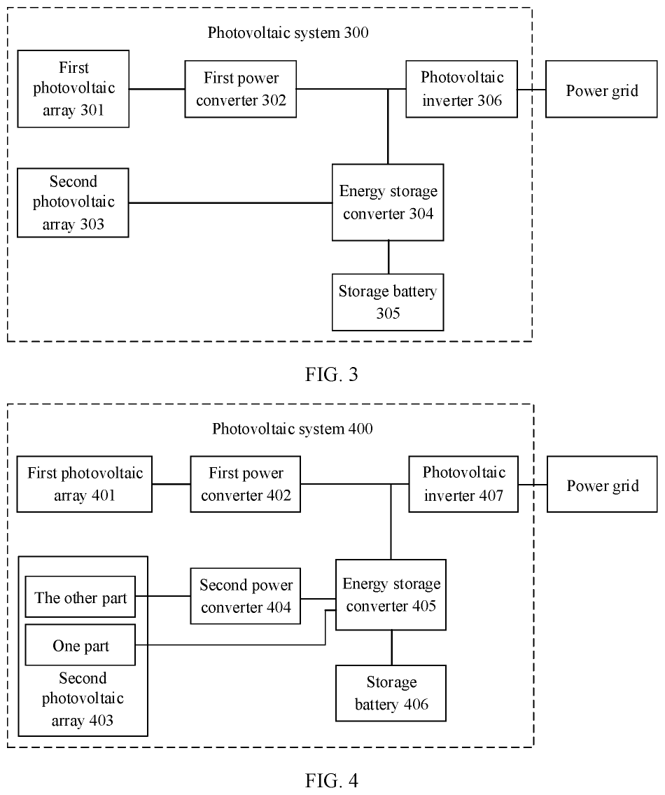

FIG. 3 is a schematic diagram 2 of an architecture of a photovoltaic system according to an embodiment of this application. As shown in FIG. 3, the photovoltaic system 300 may include a first photovoltaic array 301, a first power converter 302, a second photovoltaic array 303, an energy storage converter 304, a storage battery 305, and a photovoltaic inverter 306.

The first photovoltaic array 301 is connected to the photovoltaic inverter 306 through the first power converter 302. The second photovoltaic array 303 is connected to the energy storage converter 304. The energy storage converter 304 is connected to both the photovoltaic inverter 306 and the storage battery 305. The photovoltaic inverter 306 is connected to a power grid.

The first photovoltaic array 301 may be configured to: convert absorbed light energy into a first direct current, and output the first direct current to the first power converter 302. The first power converter 302 may be configured to convert the received first direct current into a second direct current. The second photovoltaic array 303 may be configured to convert absorbed light energy into a third direct current. The energy storage converter 304 may be configured to: receive at least one of the second direct current and the third direct current, convert a voltage value of the received direct current into a charging voltage of the storage battery, store a converted direct current in the storage battery 305, and output the direct current stored in the storage battery 305 to the photovoltaic inverter 306. The storage battery 305 is configured to store the direct current supplied by the energy storage converter 304 or supply a direct current to the energy storage converter 304. The photovoltaic inverter 306 may be configured to: receive at least one of the direct currents output by the energy storage converter 304 and the first power converter 302, convert the received direct current into an alternating current, output the alternating current to the power grid, convert an alternating current input by the power grid into a direct current, and output the direct current to the energy storage converter 304. To implement long-distance transmission of electrical energy output by the photovoltaic system 300, a voltage value of the second direct current may be greater than or equal to 1500 V.

A voltage value of the third direct current is equal to that of the second direct current, and positive and negative directions of the third direct current may be the same as those of the second direct current.

In the photovoltaic system 300 shown in FIG. 3, the energy storage converter 304 has a plurality of paths for obtaining a direct current. In one embodiment, the first power converter 302 may be connected to the energy storage converter 304, and the second photovoltaic array 303 may be directly connected to the energy storage converter 304. Because the third direct current generated by the second photovoltaic array 303 is directly output to the energy storage converter 304 and the direct current generated by the second photovoltaic array does not pass through the second power converter, the direct current output by the second photovoltaic array 303 may be output to the energy storage converter 304 with a smaller loss. This improves utilization of the electrical energy. In one embodiment, when the photovoltaic system 300 supplies electrical energy to the power grid, on some occasions when the power grid requires a small amount of electrical energy, the electrical energy required by the power grid may be directly supplied by the first power converter 302, and electrical energy generated by the second photovoltaic array 303 may be directly stored in the energy storage converter 304. When electrical energy output by the first power converter cannot satisfy a requirement of the power grid for electrical energy, at least one of the electrical energy generated by the second photovoltaic array 303 and the direct current stored in the storage battery 305 is converted into an alternating current by using the photovoltaic inverter 306, and then the alternating current is supplied to the power grid for electrical energy compensation. This improves utilization of the energy storage converter 304 and the storage battery 305, thereby reducing costs per kilowatt hour of the photovoltaic system 300.

It should be understood that, when an amount of electrical energy generated by the first photovoltaic array 301 is greater than that required by the power grid, to avoid a waste of electrical energy, excess electrical energy output by the first power converter 302 (an electrical energy portion that exceeds electrical energy required by the power grid per unit time) may be stored in the storage battery 305 by using the energy storage converter 304.

It should be understood that, when an amount of electrical energy transmitted on the power grid per unit time is greater than that required by the power grid per unit time, to avoid a waste of electrical energy, excess electrical energy transmitted on the power grid (an electrical energy portion that exceeds the electrical energy required by the power grid per unit time) may be converted into a direct current by using the photovoltaic inverter 306, and then the direct current may be stored in the storage battery 305 by using the energy storage converter 304. This improves utilization of the electrical energy.

FIG. 4 is a schematic diagram 3 of an architecture of a photovoltaic system according to an embodiment of this application. As shown in FIG. 4, the photovoltaic system 400 may include a first photovoltaic array 401, a first power converter 402, a second photovoltaic array 403, a second power converter 404, an energy storage converter 405, a storage battery 406, and a photovoltaic inverter 407.

The first photovoltaic array 401 is connected to the photovoltaic inverter 407 through the first power converter 402. One part of the second photovoltaic array 403 is directly connected to the energy storage converter 405, and the other part of the second photovoltaic array 403 is connected to the energy storage converter 405 through the second power converter 404. The energy storage converter 405 is connected to both the photovoltaic inverter 407 and the storage battery 406. The photovoltaic inverter 407 is connected to a power grid.

The first photovoltaic array 401 may be configured to: convert absorbed light energy into a first direct current, and output the first direct current to the first power converter 402. The first power converter 402 may be configured to convert the received first direct current into a second direct current. The second photovoltaic array 403 may be configured to convert absorbed light energy into a third direct current, output one part of the third direct current to the energy storage converter 405, and output the other part of the third direct current to the second power converter. The second power converter 404 may be configured to convert the received other part of the third direct current into a fourth direct current. The energy storage converter 405 may be configured to: receive at least one of the second direct current, the part of the third direct current, and the fourth direct current, convert a voltage value of the received direct current into a charging voltage of the storage battery 406, store a converted direct current in the storage battery 406, and output the direct current stored in the storage battery 406 to the photovoltaic inverter 407. The storage battery 406 is configured to store the direct current supplied by the energy storage converter 405 or supply a direct current to the energy storage converter 405. The photovoltaic inverter 407 may be configured to: receive at least one of the direct currents output by the energy storage converter 405 and the first power converter 402, convert the received direct current into an alternating current, output the alternating current to the power grid, convert an alternating current input by the power grid into a direct current, and output the direct current to the energy storage converter 405. To implement long-distance transmission of electrical energy output by the photovoltaic system 400, a voltage value of the second direct current may be greater than or equal to 1500 V.

Voltage values of the third direct current and the fourth direct current may be equal to that of the second direct current, and positive and negative directions of the third direct current and the fourth direct current may be the same as those of the second direct current.

In the photovoltaic system 400 shown in FIG. 4, the energy storage converter 405 has a plurality of paths for obtaining a direct current. In one embodiment, the first power converter 402, one part of the second photovoltaic array 403, and the second power converter 404 may all be connected to the energy storage converter 405. A major portion of the direct current received by the energy storage converter 405 is the second direct current and the fourth direct current. Therefore, impact on the system caused by an unstable voltage value of one part of the third direct current is reduced, and working stability of the photovoltaic system 400 is ensured.

In one embodiment, when the photovoltaic system 400 supplies electrical energy to the power grid, on some occasions when the power grid requires a small amount of electrical energy, the electrical energy required by the power grid may be directly supplied by the first power converter 402, and the part of the third direct current output by the second photovoltaic array 403 and the fourth direct current output by the second power converter 404 may be stored in the storage battery 406 by using the energy storage converter 405. When electrical energy generated by the first photovoltaic array 401 cannot satisfy a requirement of the power grid for electrical energy, at least one of the part of the third direct current output by the second photovoltaic array 403, the fourth direct current output by the second power converter 404, and the direct current stored in the storage battery 405 is converted into an alternating current by using the photovoltaic inverter 407, and then the alternating current is supplied to the power grid, to satisfy a requirement of the power grid for electrical energy. This improves utilization of the energy storage converter 405 and the storage battery 406, thereby reducing costs per kilowatt hour of the photovoltaic system 400.

It should be understood that, when an amount of electrical energy generated by the first photovoltaic array 401 is greater than that required by the power grid, to avoid a waste of electrical energy, excess electrical energy output by the first power converter 402 (an electrical energy portion that exceeds electrical energy required by the power grid per unit time) may be stored in the storage battery 406 by using the energy storage converter 405.

It should be understood that, when an amount of electrical energy transmitted on the power grid per unit time is greater than that required by the power grid per unit time, to avoid a waste of electrical energy, excess electrical energy transmitted on the power grid (an electrical energy portion that exceeds the electrical energy required by the power grid per unit time) may be converted into a direct current by using the photovoltaic inverter 407, and then the direct current may be stored in the storage battery 406 by using the energy storage converter 405. This improves utilization of the electrical energy.

The following describes structures of the first photovoltaic array, the first power converter, the second photovoltaic array, the second power converter, the energy storage converter, the storage battery, and the photovoltaic inverter that are in the photovoltaic system 200, the photovoltaic system 300, and the photovoltaic system 400.

1. First Photovoltaic Array

The first photovoltaic array may include a plurality of first photovoltaic subarrays. The first photovoltaic subarrays are disposed for the reason that each first photovoltaic subarray has a limited capability of outputting electrical energy, and the plurality of first photovoltaic subarrays are used to simultaneously output electrical energy, to satisfy a requirement of the power grid for electrical energy.

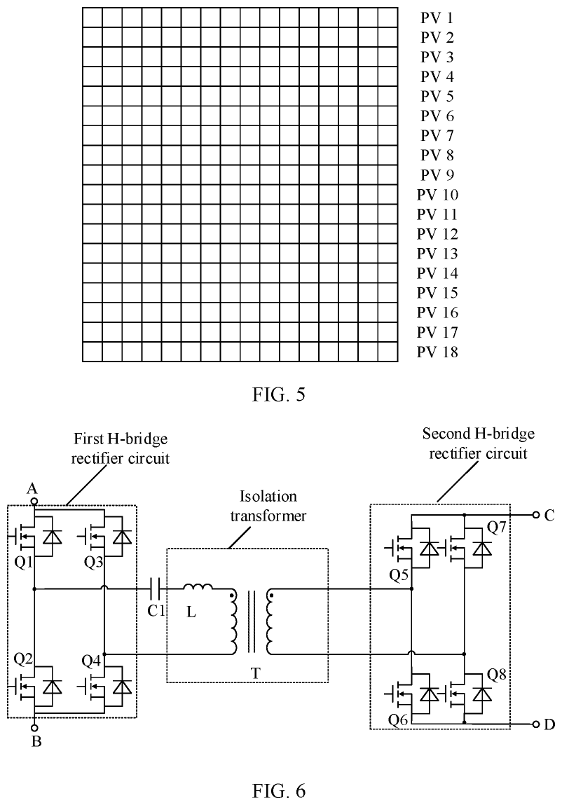

For ease of understanding, the following provides a example of a structure of the first photovoltaic array. FIG. 5 is a schematic diagram of a structure of a first photovoltaic array according to an embodiment of this application. In the first photovoltaic array shown in FIG. 5, each small square represents one photovoltaic cell. A row of photovoltaic cells in the first photovoltaic array are connected in parallel to form a photovoltaic string (PV) (for example, a PV 1 to a PV 18 in FIG. 5). Generally, a photovoltaic string may be used as a basic unit for adjusting light conversion efficiency of the first photovoltaic array. In the photovoltaic system provided in this application, any photovoltaic subarray includes at least one photovoltaic string PV.

2. First Power Converter

The first power converter may include a plurality of first photovoltaic ports connected to the plurality of first photovoltaic subarrays in a one-to-one correspondence manner, a plurality of third DC-DC converters connected to the plurality of first photovoltaic ports in a one-to-one correspondence manner, and an output port.

In one embodiment, an input end of each of the plurality of third DC-DC converters is connected to a corresponding first photovoltaic port, and an output end of each of the plurality of third DC-DC converters is connected to the output port of the first power converter.

That the plurality of first photovoltaic subarrays are connected to the plurality of first photovoltaic ports in a one-to-one correspondence manner means that a quantity of first photovoltaic subarrays included in the plurality of first photovoltaic subarrays is equal to a quantity of first photovoltaic ports included in the plurality of first photovoltaic ports, each of the plurality of first photovoltaic subarrays is corresponding to one matched first photovoltaic port, the first photovoltaic ports matched for all the first photovoltaic subarrays are different from each other, and each first photovoltaic subarray is connected to its corresponding first photovoltaic port. That the plurality of third DC-DC converters are connected to the plurality of first photovoltaic ports in a one-to-one correspondence manner means that a quantity of third DC-DC converters included in the plurality of third DC-DC converters is equal to a quantity of first photovoltaic ports included in the plurality of first photovoltaic ports, each third DC-DC converter is corresponding to one matched first photovoltaic port, the first photovoltaic ports matched for all the third DC-DC converters are different from each other, and each third DC-DC converter is connected to its matched first photovoltaic port.

Each of the plurality of third DC-DC converters may be configured to: receive, from a connected first photovoltaic port, a direct current output by a first photovoltaic subarray, convert a voltage value of the received direct current, and output a converted direct current to the photovoltaic inverter through the output port of the first power converter connected to the third DC-DC converter.

By using a structure of the first power converter, when each first photovoltaic port is connected to a corresponding first photovoltaic subarray, a photovoltaic string PV belonging to one first photovoltaic subarray is connected to a first photovoltaic port corresponding to the first photovoltaic subarray.

Each of the plurality of third DC-DC converters may include a first H-bridge rectifier circuit, an isolation transformer, and a second H-bridge rectifier circuit. A primary-side winding of the isolation transformer is coupled to the first H-bridge rectifier circuit, and a secondary-side winding of the isolation transformer is coupled to the second H-bridge rectifier circuit.

In this embodiment of this application, the third DC-DC converter uses an existing structure, that is, the third DC-DC converter includes the first H-bridge rectifier circuit, the second H-bridge rectifier circuit, and the isolation transformer. A first bridge arm of the first H-bridge rectifier circuit may serve as the input end of the third DC-DC converter to be connected to a corresponding photovoltaic port, and a second bridge arm of the second H-bridge rectifier circuit may serve as the output end of the third DC-DC converter to be connected to the output port of the first power converter.

The first H-bridge rectifier circuit includes a switching transistor and is configured to adjust a voltage of a received direct current. The second H-bridge rectifier circuit includes a switching transistor and is configured to perform rectification on a voltage-adjusted direct current. A switching transistor in each circuit of the first power converter may be a metal oxide semiconductor (MOS) transistor, may be a bipolar junction transistor (BJT), or may be another component that can implement a switching function. This is not limited in this application.

By using the first power converter, voltage adjustment and rectification processing may be performed on an obtained direct current output by the first photovoltaic array, to adjust efficiency of the direct current output by the first photovoltaic array, and electrical isolation between the first photovoltaic array and the photovoltaic inverter may further be implemented.

For ease of understanding, the following provides a example of a structure of the third DC-DC converter. The structure of the third DC-DC converter may be shown in FIG. 6. In FIG. 6, A and B serve as input ends of the third DC-DC converter to be connected to a corresponding first photovoltaic port, C and D serve as output ends of the third DC-DC converter to be connected to the output port of the first power converter, MOS transistors Q1/Q2/Q3/Q4 form the first H-bridge rectifier circuit, MOS transistors Q5/Q6/Q7/Q8 form the second H-bridge rectifier circuit, and L, C1, and T form the isolation transformer. L and T each may be a discrete structure, or L and T may be magnetically integrated.

3. Second Photovoltaic Array

The second photovoltaic array may include a plurality of second photovoltaic subarrays. The second photovoltaic subarrays are disposed for the reason that each second photovoltaic subarray has a limited capability of outputting electrical energy, and the plurality of second photovoltaic subarrays are used to simultaneously work to output electrical energy, to satisfy a requirement of the power grid for electrical energy.

A circuit structure of the second photovoltaic array may be the same as the circuit structure of the first photovoltaic array shown in FIG. 5. Details are not described in this application again.

4. Second Power Converter

The second power converter may include a plurality of second photovoltaic ports, an output port, and a plurality of fourth DC-DC converters connected to the plurality of second photovoltaic ports in a one-to-one correspondence manner.

An input end of each of the plurality of fourth DC-DC converters is connected to a corresponding second photovoltaic port, and an output end of each of the plurality of fourth DC-DC converters is connected to the output port of the second power converter.

That the plurality of second photovoltaic ports are connected to the plurality of fourth DC-DC converters in a one-to-one correspondence manner means that a quantity of fourth DC-DC converters included in the plurality of fourth DC-DC converters is equal to a quantity of second photovoltaic ports included in the plurality of second photovoltaic ports, each of the plurality of fourth DC-DC converters is corresponding to one matched second photovoltaic port, and the second photovoltaic ports matched for all the fourth DC-DC converters are different from each other.

Each of the plurality of fourth DC-DC converters may be configured to: receive, from a connected second photovoltaic port, a direct current output by a second photovoltaic subarray, convert a voltage value of the received direct current, and output a converted direct current to the energy storage converter through the output port of the second power converter connected to the fourth DC-DC converter.

By using a structure of the second power converter, when the second photovoltaic subarrays are all connected to the energy storage converter through the second power converter, the plurality of second photovoltaic ports are connected to the plurality of second photovoltaic subarrays included in the second photovoltaic array in a one-to-one correspondence manner. In one embodiment, a photovoltaic string (PV) belonging to one second photovoltaic subarray is connected to a second photovoltaic port corresponding to the second photovoltaic subarray. That the plurality of second photovoltaic ports are connected to the plurality of second photovoltaic subarrays in a one-to-one correspondence manner means that a quantity of second photovoltaic ports included in the plurality of second photovoltaic ports is equal to a quantity of second photovoltaic subarrays included in the plurality of second photovoltaic subarrays, each of the plurality of second photovoltaic ports is corresponding to one matched second photovoltaic subarray, the second photovoltaic subarrays matched for all the second photovoltaic ports are different from each other, and each second photovoltaic port is connected to its matched second photovoltaic subarray.

By using a structure of the second power converter, when some of the plurality of second photovoltaic subarrays are directly connected to the energy storage converter and some other second photovoltaic subarrays are connected to the energy storage converter through the second power converter, the plurality of second photovoltaic ports included in the second power converter are connected to the some other second photovoltaic subarrays in a one-to-one correspondence manner. That the plurality of second photovoltaic ports are connected to the some other second photovoltaic subarrays in a one-to-one correspondence manner means that a quantity of second photovoltaic ports included in the plurality of second photovoltaic ports is equal to a quantity of second photovoltaic subarrays included in the some other second photovoltaic subarrays (one of the some other second photovoltaic subarrays), each of the plurality of second photovoltaic ports is corresponding to one matched second photovoltaic subarray, the second photovoltaic subarrays matched for all the second photovoltaic ports are different from each other, and a second photovoltaic port is connected to its matched second photovoltaic subarray.

Each of the plurality of fourth DC-DC converters may be configured to: receive, from the connected second photovoltaic port, the direct current output by the second photovoltaic subarray, convert the voltage value of the received direct current, and output the converted direct current to the energy storage converter through the output port of the second power converter connected to the fourth DC-DC converter.

Each of the plurality of fourth DC-DC converters may include a third H-bridge rectifier circuit, an isolation transformer, and a fourth H-bridge rectifier circuit. A primary-side winding of the isolation transformer is coupled to the third H-bridge rectifier circuit, and a secondary-side winding of the isolation transformer is coupled to the fourth H-bridge rectifier circuit. A circuit structure of the fourth DC-DC converter may be the same as the circuit structure of the third DC-DC converter shown in FIG. 6. Details are not described in this application again.

5. Energy Storage Converter

The energy storage converter may include at least one first input port, at least one second input port, and at least one output port.

The at least one first input port is connected to the photovoltaic inverter. The at least one second input port is connected to the second power converter, or the at least one second input port is connected to the second photovoltaic array, or some of the at least one second input port are connected to the second power converter and the other some of the at least one second input port are connected to the second photovoltaic array. The at least one output port is connected to the storage battery.

By using a structure of the energy storage converter, if the second photovoltaic array is connected to the energy storage converter through the second power converter, the at least one second input port of the energy storage converter is connected to the output port of the second power converter.

By using a structure of the energy storage converter, if the second photovoltaic array is directly connected to the energy storage converter, the at least one second input port included in the energy storage converter is connected to the plurality of second photovoltaic subarrays in a one-to-one correspondence manner. That the at least one second input port is connected to the plurality of second photovoltaic subarrays in a one-to-one correspondence manner means that a quantity of second input ports included in the at least one second input port is equal to a quantity of the plurality of second photovoltaic subarrays, each of the at least one second input port is corresponding to one matched second photovoltaic subarray, the second photovoltaic subarrays matched for all the second input ports are different from each other, and each second input port is connected to its matched second photovoltaic subarray.

By using a structure of the energy storage converter, if some of the plurality of second photovoltaic subarrays are directly connected to the energy storage converter and some other second photovoltaic subarrays are connected to the energy storage converter through the second power converter, some of the at least one second input port included in the energy storage converter are connected to the some second photovoltaic subarrays in a one-to-one correspondence manner, and the output port of the second power converter is connected to some other second input ports included in the energy storage converter. That the some of the at least one second input port are connected to the some second photovoltaic subarrays in a one-to-one correspondence manner means that a quantity of second input ports included in the at least one second input port is equal to a quantity of second photovoltaic subarrays included in the some second photovoltaic subarrays, each of the at least one second input port is corresponding to one matched second photovoltaic subarray (one of the some second photovoltaic subarrays), the second photovoltaic subarrays matched for all the second input ports are different from each other, and each second input port is connected to its matched second photovoltaic subarray.

In one embodiment, the energy storage converter may further include: at least one first switch connected to the at least one first input port in a one-to-one correspondence manner, at least one second switch connected to the at least one second input port in a one-to-one correspondence manner, at least one third switch connected to the at least one output port in a one-to-one correspondence manner, and one first DC-DC converter. Each of the at least one first input port is connected to an input end of the first DC-DC converter through a correspondingly connected first switch. Each of the at least one second input port is connected to an input end of the first DC-DC converter through a correspondingly connected second switch. Each of the at least one output port is connected to an output end of the first DC-DC converter through a correspondingly connected third switch.

The first DC-DC converter may be configured to: obtain a direct current from the at least one first input port, or obtain a direct current from the at least one second input port, or obtain direct currents from the at least one first input port and the at least one second input port, reduce a voltage value of the obtained direct current, and supply a voltage-reduced direct current to the storage battery through the at least one output port; or increase a voltage value of the direct current that is supplied by the storage battery and that is obtained from the at least one output port, and output a voltage-increased direct current to the photovoltaic inverter through the at least one first input port.

It should be understood that, when the at least one first switch and the at least one second switch are closed, the at least one first input port and the at least one second input port are short-circuited to form a conduction path. In this case, a direct current output by the second photovoltaic array or the second power converter may be directly converted into an alternating current by using the photovoltaic inverter, and then the alternating current is output to the power grid.

That the at least one first input port is connected to the at least one first switch in a one-to-one correspondence manner means that a quantity of first input ports included in the at least one first input port is equal to a quantity of first switches included in the at least one first switch, each of the at least one first input port is corresponding to one matched first switch, the first switches matched for all the first input ports are different from each other, and each first input port is connected to its matched first switch. That the at least one second input port is connected to the at least one second switch in a one-to-one correspondence manner means that a quantity of second input ports included in the at least one second input port is equal to a quantity of second switches included in the at least one second switch, each of the at least one second input port is corresponding to one matched second switch, the second switches matched for all the second input ports are different from each other, and each second input port is connected to its matched second switch. That the at least one output port is connected to the at least one third switch in a one-to-one correspondence manner means that a quantity of output ports included in the at least one output port is equal to a quantity of third switches included in the at least one third switch, each of the at least one output port is corresponding to one matched third switch, the third switches matched for all the output ports are different from each other, and each output port is connected to its matched third switch.

In one embodiment, the energy storage converter further includes: at least one first DC-DC converter; at least one second DC-DC converter; at least one first switch connected to the at least one first input port in a one-to-one correspondence manner, where the at least one first switch is connected to the at least one first DC-DC converter in a one-to-one correspondence manner; at least one second switch connected to the at least one second input port in a one-to-one correspondence manner, where the at least one second switch is connected to the at least one second DC-DC converter in a one-to-one correspondence manner; and at least one third switch connected to the at least one output port in a one-to-one correspondence manner, where each of the at least one third switch is connected to one first DC-DC converter or one second DC-DC converter.

Each of the at least one first DC-DC converter may be configured to: obtain a direct current from a connected first input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through the connected first input port. Each of the at least one second DC-DC converter may be configured to: obtain a direct current from a connected second input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through a connected first input port.

That the at least one first switch is connected to the at least one first DC-DC converter in a one-to-one correspondence manner means that a quantity of first switches included in the at least one first switch is equal to a quantity of first DC-DC converters included in the at least one first DC-DC converter, each of the at least one first switch is corresponding to one matched first DC-DC converter, the first DC-DC converters matched for all the first switches are different from each other, and each first switch is connected to its matched first DC-DC converter. That the at least one second switch is connected to the at least one second DC-DC converter in a one-to-one correspondence manner means that a quantity of second switches included in the at least one second switch is equal to a quantity of second DC-DC converters included in the at least one second DC-DC converter, each of the at least one second switch is corresponding to one matched second DC-DC converter, the second DC-DC converters matched for all the second switches are different from each other, and each second switch is connected to its matched second DC-DC converter.

In this embodiment of this application, a circuit structure of each of the at least one first DC-DC converter may be the same as the circuit structure of the second DC-DC converter shown in FIG. 6, or may be a buck-boost circuit structure, to implement unidirectional boosting and unidirectional bucking functions of the first DC-DC converter. A structure of the second DC-DC converter may be the same as the structure of the first DC-DC converter.

It should be understood that the buck-boost circuit may be connected in a form of an integrated circuit, or certainly may be connected in a form of a discrete device. This is not limited in this application.

It should be understood that the energy storage converter further includes a controller, configured to control on or off of the at least one first switch, the at least one second switch, and the at least one third switch.

In one embodiment, the controller may be any one of a micro control unit (MCU), a central processing unit (CPU), or a digital signal processor (DSP). Certainly, a form of the controller is not limited to the foregoing examples.

6. Storage Battery

The storage battery may include a plurality of storage sub-batteries. The storage sub-batteries are disposed for the reason that energy storage of a single battery is limited, and the plurality of storage sub-batteries may be disposed to store a direct current output by the energy storage converter, to avoid a waste of electrical energy caused by limited energy storage of a single battery.

In one embodiment, every two of the plurality of storage sub-batteries are adjacent to each other, positive wiring terminals of any two adjacent storage sub-batteries are connected, and negative wiring terminals of the any two adjacent storage sub-batteries are connected.

7. Photovoltaic Inverter

The photovoltaic inverter may include an alternating current port, a direct current bus, and an AC/DC adapter. The direct current bus is connected between the direct current port and an input end of the AC/DC adapter. An output end of the AC/DC adapter is connected to the alternating current port, and the alternating current port is connected to the power grid.

The AC/DC adapter may be configured to: receive a direct current from the connected direct current port, convert the received direct current into an alternating current, output the alternating current to the power grid through the alternating current port, convert the alternating current that is output by the power grid and that is received from the connected alternating current port into a direct current, and output the direct current to the energy storage converter through the direct current port.

In one embodiment, the AC/DC adapter may include a fifth H-bridge rectifier circuit. A first bridge arm of the fifth H-bridge rectifier circuit may serve as the input end of the AC/DC adapter to be connected to the direct current port, and a second bridge arm of the fifth H-bridge rectifier circuit may serve as the output end of the AC/DC adapter to be connected to the alternating current port.

It should be understood that a circuit structure of the fifth H-bridge rectifier circuit may be the same as the circuit structures of the first H-bridge rectifier circuit and the second H-bridge rectifier circuit in the third DC-DC converter shown in FIG. 6.

In one embodiment, to implement electrical isolation between the photovoltaic system and the power grid, the AC/DC adapter may alternatively use a same structure as the third DC-DC converter shown in FIG. 6, that is, a structure constituted by two H-bridge rectifier circuits and one isolation transformer. Certainly, the AC/DC adapter may alternatively use another circuit structure. This is not limited in this application.

To further describe the photovoltaic system provided in this application, based on the photovoltaic system 200 shown in FIG. 2, this application provides the following feasible system architecture of the photovoltaic system.

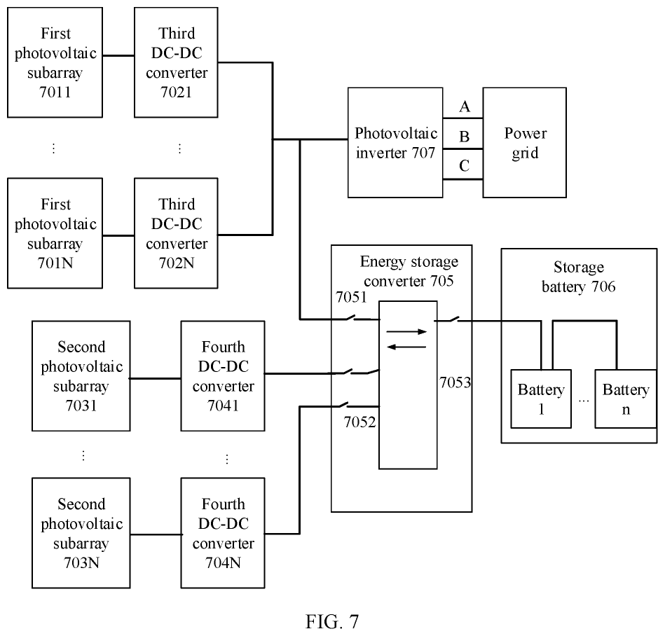

With reference to the foregoing descriptions, for example, an embodiment of this application provides a schematic diagram 1 of a structure of a photovoltaic system. In the photovoltaic system 700 shown in FIG. 7, a first photovoltaic array 701 has a plurality of first photovoltaic subarrays 7011, 7012, . . . , and 701N. A first power converter 702 includes a plurality of third DC-DC converters 7021, 7022, . . . , and 702N. A second photovoltaic array 703 has a plurality of second photovoltaic subarrays 7031, 7032, . . . , and 703N. A second power converter 704 includes a plurality of fourth DC-DC converters 7041, 7042, . . . , and 704N. An energy storage converter 705 includes a first input port 7051, a second input port 7052, and an output port 7053. A photovoltaic inverter 707 includes a direct current port 7071 and an alternating current port 7072.

In the photovoltaic system 700 shown in FIG. 7, a direct current generated by each of the first photovoltaic subarrays 7011 to 701N is directly output to a correspondingly connected third DC-DC converter 702N, that is, one of the third DC-DC converters 7021 to 702N. The third DC-DC converters 7021 to 702N respectively convert voltage values of the received direct currents, and output converted direct currents to the photovoltaic inverter 707. A direct current generated by each of the second photovoltaic arrays 7031 to 703N in the second photovoltaic array 703 is directly output to a correspondingly connected fourth DC-DC converter 704N, that is, one of the fourth DC-DC converters 7041 to 704N. The fourth DC-DC converters 7041 to 704N respectively convert the received direct currents. The energy storage converter 705 may receive at least one of the direct currents output by the third DC-DC converters 7021 to 702N and a direct current output by the photovoltaic inverter, or may receive direct currents output by the fourth DC-DC converters 7041 to 704N.

It should be understood that, when the first switch and the second switch are closed and the energy storage converter includes one first DC-DC converter, the first switch and the second switch may be short-circuited to form a wire. In this case, the direct currents output by the fourth DC-DC converters 7041 to 704N may be directly output to the photovoltaic inverter 707.

To further describe the photovoltaic system provided in this application, based on the photovoltaic system 300 shown in FIG. 3, this application provides the following feasible system architecture of the photovoltaic system.

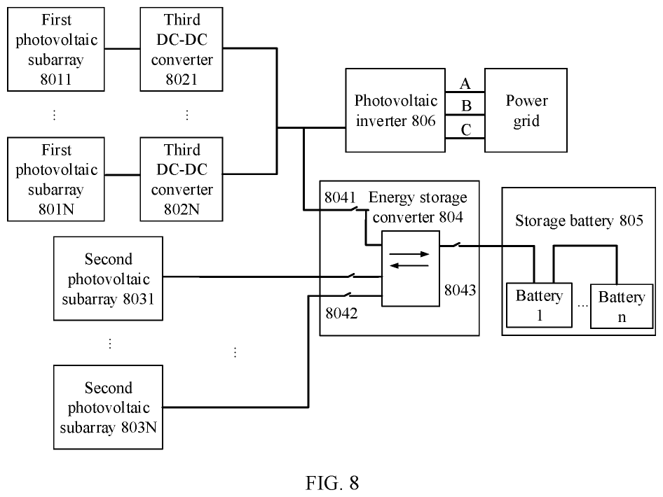

FIG. 8 is a schematic diagram 2 of a structure of a photovoltaic system according to an embodiment of this application. In the photovoltaic system 800 shown in FIG. 8, a first photovoltaic array 801 has a plurality of first photovoltaic subarrays 8011, 8012, . . . , and 801N. A first power converter 802 includes a plurality of third DC-DC converters 8021, 8022, . . . , and 802N. A second photovoltaic array 803 has a plurality of second photovoltaic subarrays 8031, 8032, . . . , and 803N. An energy storage converter 804 includes a first input port 8041, a second input port 8042, and an output port 8043. A photovoltaic inverter 806 includes a direct current port 8061 and an alternating current port 8062.

In the photovoltaic system 800 shown in FIG. 8, a direct current generated by each of the first photovoltaic arrays 8011 to 801N in the first photovoltaic array 801 is directly output to a correspondingly connected first DC-DC converter 802N, that is, one of the first DC-DC converters 8021 to 802N. The third DC-DC converters 8021 to 802N respectively convert voltage values of the received direct currents, and output converted direct currents to the photovoltaic inverter 806. Direct currents generated by the second photovoltaic arrays 8031 to 803N in the second photovoltaic array 803 are directly output to the energy storage converter 804 through the second input port 8042. The energy storage converter 804 may receive at least one of the direct currents output by the third DC-DC converters 8021 to 802N and a direct current output by the photovoltaic inverter.

It should be understood that, when the first switch and the second switch are closed and the energy storage converter includes one first DC-DC converter, the first switch and the second switch may be short-circuited to form a wire. In this case, the direct currents output by the second photovoltaic subarrays 8031 to 803N may be directly output to the photovoltaic inverter 806.

To further describe the photovoltaic system provided in this application, based on the photovoltaic system 400 shown in FIG. 4, this application provides the following feasible system architecture of the photovoltaic system.

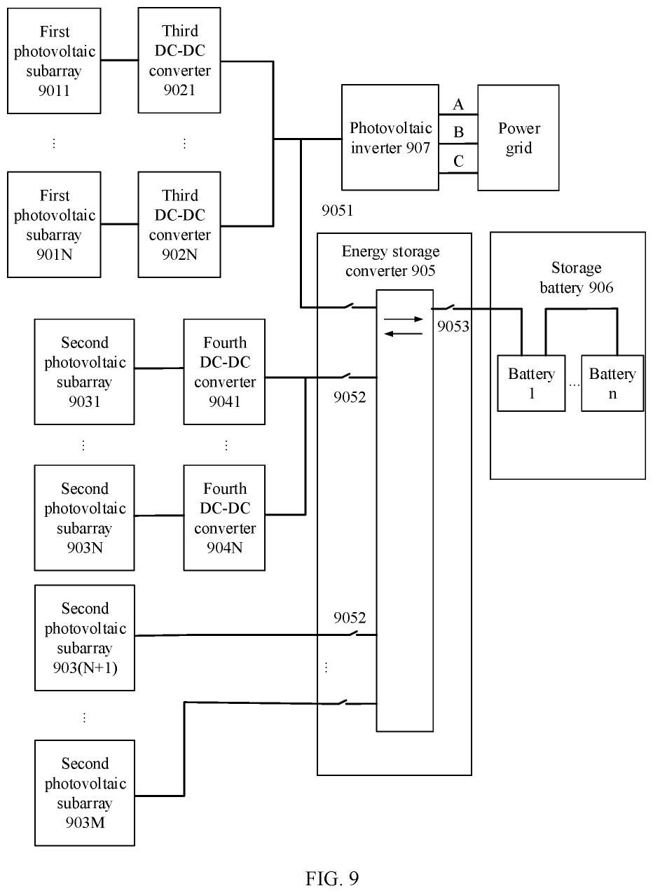

FIG. 9 is a schematic diagram 3 of a structure of a photovoltaic system according to an embodiment of this application. In the photovoltaic system 900 shown in FIG. 9, a first photovoltaic array 904 has a plurality of first photovoltaic subarrays 9011, 9012, . . . , and 901N. A first power converter 902 includes a plurality of third DC-DC converters 9021, 9022, . . . , and 902N. A second photovoltaic array 903 has a plurality of second photovoltaic subarrays 9031, 9032, . . . , 903N, 903(N+1), . . . , and 903M. A second power converter 904 includes a plurality of fourth DC-DC converters 9041, 9042, . . . , and 904N. An energy storage converter 905 includes a first input port 9051, second input ports 9052, and an output port 9054. A photovoltaic inverter 907 includes a direct current port 9071 and an alternating current port 9072.

In the photovoltaic system 900 shown in FIG. 9, a direct current generated by each of the first photovoltaic arrays 9011 to 901N in the first photovoltaic array 901 is directly output to a correspondingly connected third DC-DC converter 902N, that is, one of the third DC-DC converters 9021 to 902N. The third DC-DC converters 9021 to 902N respectively convert voltage values of the received direct currents, and output converted direct currents to the photovoltaic inverter 907. A direct current generated by each of the second photovoltaic arrays 9031 to 903N in the second photovoltaic array 903 is directly output to a correspondingly connected fourth DC-DC converter 904N, that is, one of the fourth DC-DC converters 9041 to 904N, and direct currents generated by the second photovoltaic arrays 903(N+1) to 903M are output to the correspondingly connected energy storage converter 905. The fourth DC-DC converters 9041 to 904N respectively convert voltage values of the received direct currents, and output converted direct currents to the energy storage converter 905. The energy storage converter 905 may receive, through the first input port 9051, at least one of electrical energy output by the third DC-DC converters 9021 to 902N and a direct current output by the photovoltaic inverter 907; or may receive, through the second input port, at least one of electrical energy generated by the second photovoltaic subarrays 9031 to 903N and the direct currents output by the fourth DC-DC converters 9041 to 904N.

It should be understood that, when the first switch and the second switch are closed and the energy storage converter includes one first DC-DC converter, the first switch and the second switch may be short-circuited to form a wire. In this case, at least one of the direct currents output by the fourth DC-DC converters 9041 to 904N and the direct currents generated by the second photovoltaic arrays 9031 to 903M may be directly output to the photovoltaic inverter 907.

By using the foregoing system architecture, utilization of the energy storage converter and the storage battery is improved, and utilization of the electrical energy is improved, thereby reducing costs per kilowatt hour of the system.

Although some preferred embodiments of this application have been described, persons skilled in the art can make changes and modifications to these embodiments once they learn the basic inventive concept. Therefore, the following claims are intended to be construed as to cover the preferred embodiments and all changes and modifications falling within the scope of this application.

It is clear that persons skilled in the art can make various modifications and variations to this application without departing from the scope of this application. This application is intended to cover these modifications and variations of this application provided that they fall within the scope defined by the claims of this application and equivalent technologies thereof.

1. A photovoltaic system; comprising:
a first photovoltaic array;
a first power converter;
a second photovoltaic array;
a second power converter;
an energy storage converted;
a storage battery; and
a photovoltaic inverter, wherein the first photovoltaic array is connected to the photovoltaic inverter through the first power converter, the second photovoltaic array is directly connected to the energy storage converter, or at least one part of the second photovoltaic array is connected to the energy storage converter through the second power converter, the energy storage converter is connected to the photovoltaic inverter and the storage battery, and the photovoltaic inverter is connected to a power grid.

2. The photovoltaic system according to claim 1, wherein, the energy storage converter comprises at least one first input port, at least one second input port, and at least one output port;
the at least one first input port is connected to the photovoltaic inverter;
the at least one second input port is connected to the second power converter, or the at least one second input port is connected to the second photovoltaic array, or some of the at least one second input port are connected to the second power converter and the other some of the at least one second input port are connected to the second photovoltaic array; and
the at least one output port is connected to the storage battery.

3. The photovoltaic system according to claim 2, wherein, the energy storage converter further comprises:
at least one first switch connected to the at least one first input port in a one-to-one correspondence manner;
at least one second switch connected to the at least one second input port in a one-to-one correspondence manner;
at least one third switch connected to the at least one output port in a one-to-one correspondence manner; and
one first DC-DC converter, wherein
each of the at least one first input port is connected to an input end of the first DC-DC converter through a correspondingly connected first switch;
each of the at least one second input port is connected to an input end of the first DC-DC converter through a correspondingly connected second switch;
each of the at least one output port is connected to an output end of the first DC-DC converter through a correspondingly connected third switch; and
the first DC-DC converter is configured to: obtain a direct current from the at least one first input port, or obtain a direct current from the at least one second input port, or obtain direct currents from the at least one first input port and the at least one second input port, reduce a voltage value of the obtained direct current, and supply a voltage-reduced direct current to the storage battery through the at least one output port; or increase a voltage value of the direct current that is supplied by the storage battery and that is obtained from the at least one output port, and output a voltage-increased direct current to the photovoltaic inverter through the at least one first input port.

4. The photovoltaic system according to claim 2, wherein, the energy storage converter further comprises:
at least one first DC-DC converter;
at least one second DC-DC converter;
at least one first switch connected to the at least one first input port in a one-to-one correspondence manner, wherein the at least one first switch is connected to the at least one first DC-DC converter in a one-to-one correspondence manner;
at least one second switch connected to the at least one second input port in a one-to-one correspondence manner, wherein the at least one second switch is connected to the at least one second DC-DC converter in a one-to-one correspondence manner; and
at least one third switch connected to the at least one output port in a one-to-one correspondence manner, wherein each of the at least one third switch is connected to one first DC-DC converter or one second DC-DC converter, wherein
each of the at least one first DC-DC converter is configured to: obtain a direct current from a connected first input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through the connected first input port; and
each of the at least one second DC-DC converter is configured to: obtain a direct current from a connected second input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through a connected second input port.

5. The photovoltaic system according to claim 3, wherein, the energy storage converter further comprises a controller; and
the controller is configured to control on or off of the at least one first switch, the at least one second switch, and the at least one third switch.

6. The photovoltaic system according to claim 1 wherein, the first photovoltaic array comprises a plurality of first photovoltaic subarrays, and the first power converter comprises a plurality of first photovoltaic ports connected to the plurality of first photovoltaic subarrays in a one-to-one correspondence manner;
the photovoltaic inverter comprises a direct current port, and the first power converter comprises an output port; and
the output port of the first power converter is connected to the direct current port.

7. The photovoltaic system according to claim 2, wherein, the second photovoltaic array comprises a plurality of second photovoltaic subarrays, wherein,
when the plurality of second photovoltaic subarrays are all connected to the energy storage converter through the second power converter, a plurality of second photovoltaic ports comprised in the second power converter are connected to the plurality of second photovoltaic subarrays in a one-to-one correspondence manner, and the at least one second input port of the energy storage converter is connected to an output port of the second power converter;
when some of the plurality of second photovoltaic subarrays are directly connected to the energy storage converter and some other second photovoltaic subarrays are connected to the energy storage converter through the second power converter, some of the at least one second input port comprised in the energy storage converter are connected to the some second photovoltaic subarrays in a one-to-one correspondence manner, a plurality of second photovoltaic ports comprised in the second power converter are connected to the some other second photovoltaic subarrays in a one-to-one correspondence manner, and an output port of the second power converter is connected to some other second input ports comprised in the energy storage converter; and
when the plurality of second photovoltaic subarrays are all directly connected to the energy storage converter, the at least one second input port comprised in the energy storage converter is connected to the plurality of second photovoltaic subarrays in a one-to-one correspondence manner.

8. The photovoltaic system according to claim 6, wherein, the first power converter comprises a plurality of third DC-DC converters connected to the plurality of first photovoltaic ports in a one-to-one correspondence manner, an input end of each of the plurality of third DC-DC converters is connected to a corresponding first photovoltaic port, and an output end of each of the plurality of third DC-DC converters is connected to the output port of the first power converter; and
each of the plurality of third DC-DC converters is configured to: receive, from a connected first photovoltaic port, a direct current output by a first photovoltaic subarray, convert a voltage value of the received direct current, and output a converted direct current to the photovoltaic inverter through the output port of the first power converter connected to the third DC-DC converter.

9. The photovoltaic system according to claim 7, wherein, the second power converter comprises a plurality of fourth DC-DC converters connected to the plurality of second photovoltaic ports in a one-to-one correspondence manner, an input end of each of the plurality of fourth DC-DC converters is connected to a corresponding second photovoltaic port, and an output end of each of the plurality of fourth DC-DC converters is connected to the output port of the second power converter; and
each of the plurality of fourth DC-DC converters is configured to: receive, from a connected second photovoltaic port, a direct current output by a second photovoltaic subarray, convert a voltage value of the received direct current, and output a converted direct current to the energy storage converter through the output port of the second power converter connected to the fourth DC-DC converter.

10. The photovoltaic system according to claim 6, wherein, the photovoltaic inverter comprises an alternating current port, a direct current bus, and an AC/DC adapter;
the direct current bus is connected between the direct current port and an input end of the AC/DC adapter;
an output end of the AC/DC adapter is connected to the alternating current port, and the alternating current port is connected to the power grid; and
the AC/DC adapter is configured to: receive a direct current from the connected direct current port, convert the received direct current into an alternating current, output the alternating current to the power grid through the alternating current port, convert the alternating current that is output by the power grid and that is received from the connected alternating current port into a direct current, and output the direct current to the energy storage converter through the direct current port.

11. The photovoltaic system according to claim 1, wherein, a voltage value of a voltage output by the second power converter is greater than or equal to 1500 V.

12. The photovoltaic system according to claim 1, wherein, the storage battery comprises a plurality of storage sub-batteries, every two of the plurality of storage sub-batteries are adjacent to each other, positive wiring terminals of any two adjacent storage sub-batteries are connected, and negative wiring terminals of the any two adjacent storage sub-batteries are connected.

13. The photovoltaic system according to claim 1, wherein, the storage battery comprises a lead carbon battery, a lithium iron phosphate battery, a ternary polymer lithium battery, a sodium sulfur battery, or a flow battery.

14. A photovoltaic system including a first and second photovoltaic array, a first and second power convertor, an energy storage converter, and a storage battery, wherein the photovoltaic system comprises:
a photovoltaic inverter, wherein the first photovoltaic array is connected to the photovoltaic inverter through the first power converter, the second photovoltaic array is directly connected to the energy storage converter, or at least one part of the second photovoltaic array is connected to the energy storage converter through the second power converter, the energy storage converter is connected to the photovoltaic inverter and the storage battery, and the photovoltaic inverter is connected to a power grid.

15. The photovoltaic system according to claim 14, wherein, the energy storage converter comprises at least one first input port, at least one second input port, and at least one output port;
the at least one first input port is connected to the photovoltaic inverter;
the at least one second input port is connected to the second power converter, or the at least one second input port is connected to the second photovoltaic array, or some of the at least one second input port are connected to the second power converter and the other some of the at least one second input port are connected to the second photovoltaic array; and
the at least one output port is connected to the storage battery.

16. The photovoltaic system according to claim 15, wherein, the energy storage converter further comprises:
at least one first switch connected to the at least one first input port in a one-to-one correspondence manner;
at least one second switch connected to the at least one second input port in a one-to-one correspondence manner;
at least one third switch connected to the at least one output port in a one-to-one correspondence manner; and
one first DC-DC converter, wherein
each of the at least one first input port is connected to an input end of the first DC-DC converter through a correspondingly connected first switch;
each of the at least one second input port is connected to an input end of the first DC-DC converter through a correspondingly connected second switch;
each of the at least one output port is connected to an output end of the first DC-DC converter through a correspondingly connected third switch; and
the first DC-DC converter is configured to: obtain a direct current from the at least one first input port, or obtain a direct current from the at least one second input port, or obtain direct currents from the at least one first input port and the at least one second input port, reduce a voltage value of the obtained direct current, and supply a voltage-reduced direct current to the storage battery through the at least one output port; or increase a voltage value of the direct current that is supplied by the storage battery and that is obtained from the at least one output port, and output a voltage-increased direct current to the photovoltaic inverter through the at least one first input port.

17. The photovoltaic system according to claim 15, wherein, the energy storage converter further comprises:
at least one first DC-DC converter;
at least one second DC-DC converter;
at least one first switch connected to the at least one first input port in a one-to-one correspondence manner, wherein the at least one first switch is connected to the at least one first DC-DC converter in a one-to-one correspondence manner;
at least one second switch connected to the at least one second input port in a one-to-one correspondence manner, wherein the at least one second switch is connected to the at least one second DC-DC converter in a one-to-one correspondence manner; and
at least one third switch connected to the at least one output port in a one-to-one correspondence manner, wherein each of the at least one third switch is connected to one first DC-DC converter or one second DC-DC converter, wherein
each of the at least one first DC-DC converter is configured to: obtain a direct current from a connected first input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through the connected first input port; and
each of the at least one second DC-DC converter is configured to: obtain a direct current from a connected second input port, reduce a voltage value of the obtained direct current, and supply a voltage-reduced direct current to the storage battery through a connected output port; or increase a voltage value of the direct current that is supplied by the storage battery and that is obtained from the connected output port, and output a voltage-increased direct current to the photovoltaic inverter through a connected second input port.

18. The photovoltaic system according to claim 16, wherein, the energy storage converter further comprises a controller; and
the controller is configured to control on or off of the at least one first switch, the at least one second switch, and the at least one third switch.

19. The photovoltaic system according to claim 14 wherein, the first photovoltaic array comprises a plurality of first photovoltaic subarrays, and the first power converter comprises a plurality of first photovoltaic ports connected to the plurality of first photovoltaic subarrays in a one-to-one correspondence manner;
the photovoltaic inverter comprises a direct current port, and the first power converter comprises an output port; and
the output port of the first power converter is connected to the direct current port.

20. The photovoltaic system according to claim 15, wherein, the second photovoltaic array comprises a plurality of second photovoltaic subarrays, wherein,
when the plurality of second photovoltaic subarrays are all connected to the energy storage converter through the second power converter, a plurality of second photovoltaic ports comprised in the second power converter are connected to the plurality of second photovoltaic subarrays in a one-to-one correspondence manner, and the at least one second input port of the energy storage converter is connected to an output port of the second power converter;
when some of the plurality of second photovoltaic subarrays are directly connected to the energy storage converter and some other second photovoltaic subarrays are connected to the energy storage converter through the second power converter, some of the at least one second input port comprised in the energy storage converter are connected to the some second photovoltaic subarrays in a one-to-one correspondence manner, a plurality of second photovoltaic ports comprised in the second power converter are connected to the some other second photovoltaic subarrays in a one-to-one correspondence manner, and an output port of the second power converter is connected to some other second input ports comprised in the energy storage converter; and
when the plurality of second photovoltaic subarrays are all directly connected to the energy storage converter, the at least one second input port comprised in the energy storage converter is connected to the plurality of second photovoltaic subarrays in a one-to-one correspondence manner.
